(19) United States
(12) Patent Application Publication
(10) Pub. No.: US 2017/0121528 A1
(43) Pub. Date: May 4, 2017

(54) COATING COMPOSITION, PLASTIC FILM PREPARED BY USING THE SAME, AND PREPARATION METHOD THEREOF

(71) Applicant: LG CHEM, LTD., Seoul (KR)

(72) Inventors: Heon KIM, Daejeon (KR); Yeong Rae CHANG, Daejeon (KR); Soon Hwa JUNG, Daejeon (KR); Young Suk KIM, Daejeon (KR)

(21) Appl. No.: 15/318,512

(22) PCT Filed: Jun. 17, 2015
(86) PCT No.: PCT/KR2015/006140

§ 371 Date: Dec. 13, 2016

(30) Foreign Application Priority Data
Jun. 17, 2014 (KR) 10-2014-0073636
Jun. 17, 2014 (KR) 10-2014-0073637
Jun. 16, 2015 (KR) 10-2015-0085227

(51) Int. Cl. C09D 4/06; C09D 7/12; C09D 133/14

(52) U.S. Cl. CPC C09D 4/06; C09D 133/14; C09D 7/1216; C09D 7/1266; C08K 3/36

(57) ABSTRACT

The present invention relates to: a coating composition; a plastic film prepared by using the same; and a preparation method therefor, and more specifically to a coating composition capable of forming a plastic film exhibiting high hardness and excellent processability; a plastic film being prepared by using the same and exhibiting a three-dimensional structure; and a preparation method thereof.

### BACKGROUND OF THE INVENTION

(a) Field of the Invention

This application claims the benefit of priority based on Korean Patent Application No. 10-2014-0073636 filed on Jun. 17, 2014, Korean Patent Application No. 10-2014-0073637 filed on Jun. 17, 2014 and Korean Patent Application No. 10-2015-0085227 filed on Jun. 16, 2015 with the Korean Intellectual Property Office, the disclosures of which are incorporated herein by reference in their entirety.

The present invention relates to a coating composition, a plastic film prepared by using the same, and a preparation method therefor and, more specifically, to a coating composition capable of forming a plastic film exhibiting high hardness and excellent processability, a plastic film being prepared by using the same and exhibiting a three-dimensional structure, and a preparation method thereof.

(b) Description of the Related Art

With recent advancements of mobile devices such as smartphones and tablet PC, there has been a need for thinning and slimming of the display devices. In general, glass or tempered glass, as a material with superior mechanical properties, has been used for window or the front panel of these display mObile devices. However, the glass may be problematic as it becomes the cause of increasing the weight of the mobile devices due to the weight of glass itself and can be damaged by an external impact.

Accordingly, the research for plastic resin is actively underway as a material which can replace the glass. A plastic resin film is lightweight and less fragile, and thus is suitable for the trend of pursuing lighter mobile devices. Specifically, in order to arrive at a film having high hardness and abrasion resistance, films for coating a hard coating layer made of plastic resins have been proposed.

A method of increasing the thickness of the hard coating layer may be considered as a method of increasing the surface hardness of the hard coating layer. It is necessary to design a uniform thickness of the hard coating layer in order to secure the surface hardness to the extent that it can replace the glass. However, although the surface hardness may increase as the thickness of the hard coating layer increases, due to the curing shrinkage of the hard coating, larger wrinkles or curls are formed and at the same time cracking or peeling of the layer may easily occur, and thus it may not be easily applied into practice.

Korea Patent Application Laying-Open No. 2010-0041992 discloses a plastic film composition using a binder resin including ultraviolet-curable polyurethane acrylate-based oligomers excluding monomers. However, the plastic film has a pencil hardness of 3H which is not sufficient to replace the display glass panel.

On the other hand, due to aesthetic or functional reasons, displays in which a portion of the edge is bent or which has an overall three-dimensional shape of a curve have recently gained attention, and this trend has been specifically highlighted in mobile devices such as smart phones, tablet PC, etc. However, when using glass as a cover plate for protecting the display of such a three-dimensional shape, there is a greater risk of damage due to the nature of glass as being heavy and vulnerable to external impact.

Although the plastic resin film is lightweight and less fragile compared to glass, it is difficult to prepare a film which has a three-dimensional structure while showing the same level of high hardness as glass.

### SUMMARY OF THE INVENTION

For resolving the aforesaid problems of the prior arts, it is an object of the present invention to provide a coating composition which can have no occurrence of curls or cracks and have excellent processability while exhibiting high hardness after curing, thereby forming a plastic film not only in the form of a flat-type, but also of a three-dimensional structure in which at least a portion is bent.

Also, it is another object of the present invention to provide a plastic film having a three-dimensional structure while exhibiting high hardness, and a preparation method thereof.

To achieve the above objects, one aspect of the present invention is to provide a coating composition including a dual-curable binder including a thermocurable functional group and a photocurable functional group within a molecule, a photoinitiator, a heat-curing agent, and inorganic fine particles.

Another aspect of the present invention is to provide a plastic film in which at least a portion is bent-shaped, including a support substrate; and a coating layer formed on at least one surface of the support substrate, wherein the coating layer comprises a cured product of a dual-curable binder including a thermocurable functional group and a photocurable functional group within a molecule, and inorganic fine particles.

Still another aspect of the present invention is to provide a method for preparing a plastic film including:

applying a coating composition including a dual-curable binder including a thermocurable functional group and a photocurable functional group within a molecule, a photoinitiator, a heat-curing agent, and inorganic fine particles, on at least one surface of a support substrate;

forming a semi-cured coating layer by subjecting the applied coating composition to a first curing;

subjecting a support substrate on which the semi-cured coating layer is formed, to a thermoforming; and

subjecting the semi-cured coating layer to a second curing.

The coating composition of the present invention can exhibit high hardness, impact resistance, scratch resistance, and high transparency, have excellent processability and lead to occurrence of fewer curls or cracks, thereby providing a plastic film not only in the form of a flat-type, but also of a three-dimensional structure in which at least a portion is bent.

According to the present invention, there may be provided a film exhibiting high hardness, impact resistance, scratch resistance and high transparency, and also having excellent processability, and thus occurring fewer curls or cracks and having a structure in which at least a portion of the film is bent.

Accordingly, the plastic film of the present invention may provide a plastic film having a three-dimensional structure, for example, a film in which one edge or edges facing each other are bended or all of four edges an bended, or which is entirely bent-shaped while having high hardness.

As a replacement of the cover plates made of glass or tempered glass, these plastic films can be usefully applied not only for conventional flat displays, but also as cover plates of mobile devices of various shapes, display devices, front panels of various dashboards, display unites, etc.

Further, according to the preparation method of the plastic film of the present invention, the plastic film can be prepared at low cost and by a simple process.

### BRIEF DESCRIPTION OF THE DRAWINGS

FIG. 1 is a perspective view illustrating the plastic film according to one embodiment of the present invention.

FIG. 2 is a cross-sectional view illustrating the plastic film of FIG. 1.

FIG. 3 is a perspective view illustrating the plastic film according to another embodiment of the present invention.

FIG. 4 is a cross-sectional view illustrating the plastic film of FIG. 3.

FIG. 5 is a perspective view illustrating the plastic film according to another embodiment of the present invention.

FIG. 6 is a cross-sectional view illustrating the plastic film of FIG. 5.

### DETAILED DESCRIPTION OF THE EMBODIMENTS

The present invention provides a coating composition including a dual-curable binder including a thermocurable functional group and a photocurable functional group within a molecule, a photoinitiator, a heat-curing agent, and inorganic fine particles.

Further, the present invention provides a plastic film in which at least a portion is bent-shaped,

including a support substrate; and a coating layer formed on at least one surface of the support substrate, wherein the coating layer includes a cured product of a dual-curable binder including a thermocurable functional group and a photocurable functional group within a molecule, and inorganic fine particles.

Furthermore, the present invention provides a method for preparing a plastic film including:

applying a coating composition including a dual-curable binder including a thermocurable functional group and a photocurable functional group within a molecule, a photoinitiator, a heat-curing agent, and inorganic fine particles, on at least one surface of a support substrate;

forming a semi-cured coating layer by subjecting the applied coating composition to a first curing;

subjecting a support substrate on which the semi-cured coating layer is formed, to a thermoforming; and

subjecting the semi-cured coating layer to a second curing.

It will be understood that, the terms “first,” “second,” etc. may be used herein to describe various elements, and these terms are only used to distinguish one element from another element.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “include”, “comprise”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

In addition, it will be understood that when an element is referred to as being “on”, “over”, “disposed on”, “disposed over”, “deposited on”, or “deposited over” another element, it can be directly on the other element or intervening elements may also be present.

Accordingly, while example embodiments of the invention are capable of applying various modifications and alternative forms, embodiments thereof are shown by way of example in the drawings and will herein be described in detail. It should be understood, however, that it is not intended to limit example embodiments of the present invention to the particular forms disclosed. On the contrary, example embodiments are to cover all modifications, equivalents, and alternatives falling within the scope of the invention.

Hereinafter, the coating composition, plastic film, and the preparation method thereof according to the present invention will be described in more detail.

Coating Composition

In one aspect, the present invention provides a coating composition including a dual-curable binder including a thermocurable functional group and a photocurable functional group within a molecule, a photoinitiator, a heat-curing agent, and inorganic fine particles.

The thermocurable functional group as used herein refers to a functional group capable of forming a cured product by cross polymerization with each other by heating at a certain temperature or higher, for example, it may include an epoxy group, a vinyl group, a hydroxy group, an alkoxy group, a thiol group, a melamine group or a siloxane group, etc., but is not limited thereto.

The photocurable functional group as used herein refers to a functional group capable of forming a cured product by cross polymerization with each other by UV irradiation, for example, it may include an acrylate group, a methacrylate group, a vinyl group or a thiol group, etc., but is not limited thereto.

In addition, the binder including a thermocurable functional group and a photocurable functional group within a molecule throughout the specification may be referred to as a dual-curable binder, and is used as having the same meaning.

According to one embodiment of the present invention, the dual-curable binder may have a weight average molecular weight in the range of about 10,000 to about 300,000 g/mol, or about 15,000 to about 200,000 g/mol, or about 20,000 to about 50,000 g/mol. In addition, the equivalent weight of the thermocurable functional group and the photocurable functional group of the dual-curable binder may be each independently identical or different in the range of about 80 to about 1,500 g/eq, or about 100 to about 1,000 g/eq, or about 200 to 600 g/eq.

When the dual-curable binder is used compared to a coating composition in which two types of single-curable binders, that is, a binder including only thermocurable functional groups or a binder including only photocurable functional groups, are mixed, it has advantages in that the tackiness of the coating layer after the first curing is favorable, thereby facilitating a secondary processing such as thermoforming, and that the crosslinking density can be increased, thereby enhancing the mechanical strength. However, the use of the binder including only thermocurable functional groups and the binder including only photocurable functional groups is not excluded, and other photocurable binders and/or thermocurable binders may further be included in addition to the dual-curable binder in order to enhance the physical properties of the coating layer.

The dual-curable binder having the physical properties described above can be directly polymerized, or commercially available products can be purchased and used. In addition, the dual-curable binder may include only one type, or may be used in combination of two or more types of dual-curable binders.

According to one embodiment of the invention, the thermocurable functional group and the photocurable functional group within the dual-curable binder may be contained in a molar ratio of about 1:9 to about 9:1, or about 3:7 to about 7:3, or about 4:6 to about 6:4. When the thermocurable functional group and the photocurable functional group are within the range above, it may provide a plastic film having a good processability while maintaining high hardness.

The dual-curable binder may be included in an amount of about 10 to about 50 parts by weight based on 100 parts by weight of the coating composition. When the dual-curable binder is within the range above, it may provide a plastic film having good processability which enables bending formation while maintaining high hardness.

The coating composition of the present invention includes a photoinitiator.

The photoinitiator may include 1-hydroxy-cyclohexyl-phenyl ketone, 2-hydroxy-2-methyl-1-phenyl-1-propanone, 2-hydroxy-1-[4-(2-hydroxy-hydroxyethoxy)phenyl]-2-methyl-1-propanone, methyl benzoylformate, α,α-dimethoxy-α-phenyl acetophenone, 2-benzoyl-2-(dimethylamino)-1-[4-(4-morpholinyl)phenyl]-1-butanone, 2-methyl-1-[4-(methylthio) phenyl]-2-(4-morpholinyl)-1-propanone, diphenyl(2,4,6-trimethylbenzoyl)-phosphine oxide or bis(2,4,6-trimethylbenzoyl)-phenyl phosphineoxide, but is not limited thereto. In addition, the commercially available products thereof include Irgacure 184, Irgacure 500, Irgacure 651, Irgacure 369, Irgacure 907, Darocur 1173, Darocur MBF, Irgacure 819, Darocur TPO, Irgacure 907, Esacure KIP 100F etc. These photoinitiators may be used alone or in combination with other two or more types.

The content of the photo-initiator is not particularly limited, but the photo-initiator may be included in an amount of about 0.1 to about 5 parts by weight based on 100 parts by weight of the coating composition in order to achieve effective photopolymerization without disturbing the physical properties of the entire coating composition.

The coating composition of the present invention includes a heat-curing agent.

The heat-curing agent can be used by selecting an appropriate compound depending on the type of thermocurable functional group, for example, when the thermocurable functional group is a hydroxy group (—OH), materials in the form of a monomer, dimer, trimer or polymer including an isocyanate group (—NCO) may be used as a heat-curing agent, and more specifically, toluene diisocyanate (TDI), hexamethylene diisocyanate (HDI), or isophorone diisocyanate (IPDI), etc. may be used, but is not limited thereto. Further, dibutyltindilaurate (DBTDL) may be added and used as a catalyst accelerating the thermocuring reaction.

In addition, heat-curing agent that can be used depending on the type of the thermocurable functional group includes zinc octoate, iron acetylacetonate, N,N-dimethyl ethanolamine, Methylene diamine, etc., but is not limited thereto. These heat-curing agents may be used alone or in combination with other two or more types.

The content of the heat-curing agent is not particularly limited, but the heat-curing agent may be included in an amount of about 10 to about 50 parts by weight based on 100 parts by weight of the coating composition in order to achieve effective photopolymerization without disturbing the physical properties of the entire coating composition.

The coating layer of the present invention includes inorganic fine particles. The inorganic particles serve to enhance the hardness of the coating layer.

According to one embodiment of the invention, the inorganic fine particles having a nanoscale diameter, for example, nano particles with a particle dimeter of about 100 nm or below, or about 10 to about 100 nm, or about 10 to about 50 nm may be used. In addition, the inorganic fine particles include, for example, fine particles of silica, aluminum oxide particles, titanium oxide particles or zinc oxide particles, etc.

According to one embodiment of the invention, the inorganic fine particles may be included in an amount of about 1 to about 40 parts by weight or about 5 to about 30 parts by weight based on 100 parts by weight of the coating composition. When the inorganic fine particles are within the ranges above, the effect of enhancing the hardness of the plastic film according to the addition of inorganic fine particles may be achieved within the range which does not degrade the physical properties such as flexibility, etc.

The coating composition may further optionally include an organic solvent for suitable flow and coating characteristics.

According to one embodiment of the present invention, the organic solvent may be used along or in combination which includes alcohol-based solvents such as methanol, ethanol, isopropyl alcohol, butanol, alkoxy-based solvents such as 2-methoxyethanol, 2-ethoxyethanol, 1-methoxy-2-propanol, ketone-based solvents such as acetone, methyl ethyl ketone, methyl isobutyl ketone, methyl propyl ketone, cyclohexanone, ether-based solvent such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethyl glycol monopropyl ether, diethyl glycol monobutyl ether, diethylene glycol-2-ethyl hexyl ether, and aromatic solvents such as benzene, toluene, xylene, etc.

According to one embodiment of the invention, the content of the organic solvent may be variously adjusted within the range which does not degrade the physical properties of the coating composition, and thus is not particularly limited, but the organic solvent may be included such that the weight ratio of solid content: organic solvent is within the range of about 70:30 to 99:1 based on 100 parts by weight of the solid content in the coating composition. When the organic solvent is within the range above, it may have suitable flow and coating characteristics.

On the other hand, the coating compositions of the present invention may further include, in addition to the above-described components, additives commonly used in the technical to which the prevent invention pertains, such as a surfactant, an anti-yellowing agent, a leveling agent, an antifouling agent, etc. Further, the contents thereof may be variously adjusted within the range which does not degrade the physical properties of the coating composition, and thus are not particularly limited, but they may be included, for example, in an amount of about 0.1 to 10 parts by weight based on 100 parts by weight of the entire coating composition.

According to one embodiment of the invention, the coating composition may include a surfactant as an additive, the surfactant may be a fluorinated acrylate, a fluorine-based surfactant or a silicon-based surfactant having one or two functional groups. Here, the surfactants may be included as being dispersed in or crosslinked to the crosslinked copolymer.

In addition, the anti-yellowing agent may be included as the additives, and the anti-yellowing agent may include a benzophenone-based compound or a benzotriazole-based compound.

According to one embodiment of the invention, the coating composition may further include a photocurable binder such as 3 to 6-functional acrylate-based monomer.

The 3 to 6-functional acrylate-based monomer may include trimethylolpropane triacrylate (TMPTA), trimethylolpropane ethoxy triacrylate (TMPEOTA), glycerol propoxylated triacrylate (GPTA), pentaerythritol tetraacrylate (PETA), or dipentaerythritol hexaacrylate (DPHA), etc. The 3 to 6-functional acrylate-based monomer may be used alone or in combination with different types.

The 3 to 6-functional acrylate-based monomers are cross-linked and polymerized by ultraviolet irradiation to form a crosslinked copolymer, and it may increase hardness of the coating layer by including the crosslinked copolymer.

According to one embodiment of the invention, the 3 to 6-functional acrylate-based monomers may be included in an amount of about 5 to about 50 parts by weight, or about 10 to 40 parts by weight based on 100 parts by weight of the coating composition. When the 3 to 6-functional acrylate-based monomers are within the ranges above, the effect of enhancing the hardness of the plastic film according to the addition of acrylate-based monomers may be achieved within the range which does not degrade the physical properties such as flexibility, etc.

According to one embodiment of the invention, the viscosity of the coating composition is not particularly limited as long as it falls within the range having suitable flow and coating characteristics, and for example, it may have a viscosity of 1,200 cps or below at 25° C.

A film including a coating layer formed by using the coating composition of the present invention exhibits high hardness, high processability, impact resistance, flexibility, scratch resistance, high transparency, durability, light resistance, high transmittance, etc., and thus can be useful in a variety of fields.

According to one embodiment of the present invention, a film in the form of a flat-type or three-dimensional structure may be prepared by thermocuring and photocuring processes using the coating composition.

The plastic film formed by using the coating composition of the present invention can be used in various fields. For example, it may be used as a cover plate of mobile terminals, smart phones or tablet PC, and various displays with a flat shape or a three-dimensional shape, or as a device substrate.

Plastic Film and Preparation Method Therefor

In another aspect, the present invention provides A plastic film in which at least a portion is bent-shaped, including a support substrate; and a coating layer formed on at least one surface of the support substrate, wherein the coating layer includes a cured product of a dual-curable binder including a thermocurable functional group and a photocurable functional group within a molecule, and inorganic fine particles.

As for the plastic film of the present invention, the support substrate on which the coating layer is formed is a commonly used transparent plastic resin, and a resin having a glass transition temperature (Tg) of about 80 to 250° C. or about 100 to 150° C. may be used. When the glass transition temperature of the support substrate is lower than the range described above, there is a risk that the thermal stability or durability of a product may be degraded, whereas when the temperature is higher than the range described above, there is a possibility that the coating layer may be modified during thermoforming process for forming a bent shape.

Any transparent plastic resin having the glass transition temperature within the above range may be used regardless of the preparation method of support substrate, such as stretched film or non-stretched film, or the materials, without limitation. More specifically, according to one embodiment of the present invention, the support substrate may be, for example, a film including polyester such as polyethylene terephthalate (PET), cyclic olefin polymer (COP), cyclic olefin copolymer (COC), polyacrylate (PAC), polycarbonate (PC), polymethylmethacrylate (PMMA), polyetheretherketon (PEEK), polyethylenenaphthalate (PEN), polyetherimide (PEI), polyimide (PI), triacetylcellulose (TAC), methyl methacrylate (MMA), or a fluorine-based resin, etc. The support substrate may be in a single-layer structure or a multi-layer structure including at least two substrates composed of the same or different materials, as needed, but is not limited thereto.

According to one embodiment of the invention, the support substrate may be a substrate having a multi-layer structure of polyethylene terephthalate (PET) or a substrate having a structure with at least two layers formed by coextrusion of polymethyl methacrylate (PMMA)/polycarbonate (PC).

Further, according to one embodiment of the invention, the support substrate may be a substrate including a copolymer of polymethylmethacrylate (PMMA) and polycarbonate (PC).

The thickness of the support substrate is not particularly limited, but a substrate having a thickness of about 100 to about 1,000 μm, or about 200 to about 500 pin, the range of which satisfies the hardness of the plastic film and the physical properties of processability.

The plastic film of the present invention includes a coating layer formed on at least one surface of the support.

Alternatively, the plastic film of the present invention includes a coating layer formed on both surfaces of the support substrate.

Further, according to one embodiment of the invention, the thickness ratio of the support substrate and the coating layer may be each independently about 1:0.1 to about 1:2, or about 1:0.5 to about 1:1.5. When the thickness ratio is within the above range, it may form a plastic film exhibiting high hardness while occurring fewer curls and cracks.

As for the plastic film of the present invention, the coating layer includes a cured product of a dual-curable binder including a thermocurable functional group and a photocurable functional group within a molecule, and inorganic fine particles.

The coating layer may be formed by applying the coating composition described above, that is, the coating composition including a dual-curable binder including a thermocurable functional group and a photocurable functional group within a molecule, a photoinitiator, a heat-curing agent, and inorganic fine particles, followed by performing semi-curing, thermoforming, and full curing.

The detailed description of the coating composition, and of the dual-curable binder, photoinitiator, heat-curing agent, inorganic fine particles, or other components, which may be included therein, and the specific examples thereof are as described above.

Compared to a case of using a coating composition in which two types of binders each containing thermocurable functional groups or photocurable functional groups are mixed, a case of using the dual-curable binder of the present invention provides advantages in that the tackiness of the coating layer after first curing is favorable, thereby facilitating a secondary processing such as thermoforming, and that the crosslinking density can be increased, thereby enhancing the mechanical strength. However, the use of the binder including only thermocurable functional groups and the binder including only photocurable functional groups is not excluded, and other photocurable binders and/or thermocurable binders may further be included in addition to the dual-curable binder in order to enhance the physical properties of the coating layer.

According to one embodiment of the invention, the thermocurable functional group and the photocurable functional group may be contained in a molar ratio of about 1:9 to about 9:1, or about 3:7 to about 7:3, or about 4:6 to about 6:4. When the thermocurable functional group and the photocurable functional group are within the ranges above, it may provide a plastic film having a good processability while maintaining high hardness.

The plastic film of the present invention may be formed by applying the coating composition including the components described above on the support substrate, followed by subjecting it to semi-curing, thermoforming, and complete curing.

According to one embodiment of the invention, the coating layer may be applied such that the thickness after curing is within the range of about 20 μm or higher, for example, about 20 to about 300 μm, or about 50 to about 300 μm, or about 20 to about 200 μm, or about 50 to about 200, μm or about 20 to about 150 μm, or about 50 to about 150 μm, or about 20 to about 150 μm, or about 70 to about 150 μm. When the thickness is below the optimal range, sufficient mechanical strength may not be obtained, whereas when the thickness exceeds the optimal range, there is a possibility that the tensile stress applied to the bent portion may increase beyond the limitation during thermoforming process.

According to one embodiment of the invention, the coating layer may only be formed on one surface of the support substrate.

According to one embodiment of the invention, the coating layer may be formed on both surfaces of the support substrate.

According to the present invention, it may provide a plastic film which includes a cured product of the dual-curable binder and inorganic fine particles and in which at least one portion is bent-shaped.

That is, the thermoforming process may be performed when the thermocurable functional group and the photocurable functional group are partially cured by adjusting the degree of curing of the dual-curable binder, which enables a plastic film in which at least one portion is bent-shaped to be provided.

More specifically, only some portions of the thermocurable functional group and the photocurable functional group included in the dual-curable binder applied to the support substrate are subjected to curing and made into a semi-cured state. After that, when the support substrate having the semi-cured state coating layer is placed in a mold with certain shape, followed by applying heat, at least one portion of the film may be formed into a bent shape depending on the shape of the mold. This is known as thermoforming process. Thereafter, a plastic film having a three-dimensional structure fixed as the shape of the mold may be obtained by curing uncured functional groups.

With respect to the coating composition using only acrylate monomers, which are conventionally used as a binder for a plastic resin, when the acrylate monomers are formed into a three-dimensional shape in a partially cured state, followed by curing the remaining portions, a crack may occur by stress of the bent portion, or the coating layer may fall apart from the support substrate as the adhesion strength therebetween decreases, which were problematic, and thus, it was difficult to prepare a film which is bent- or curve-shaped. Further, the uncured acrylate monomers exhibit tackiness, and when they make contact with a mold, the surface of the coating layer may undergo deformation, and thus, the forming method was extremely limited.

However, by using the cured product of the dual-curable binder containing the thermocurable functional group and the photocurable functional group within a molecule, the plastic film of the present invention may prevent the occurrence of cracks during or after forming process without decreasing adhesion strength to the support substrate, and enable formation of a bent portion with a wide range of curvature radius.

Further, it is possible to form a coating layer with a large thickness in order to exhibit high hardness without occurrence of cracks. That is, according to the plastic film of the present invention, it is possible to form a coating layer with a large thickness by further including the thermocurable functional group, in addition to the photocurable functional group, thereby maintaining high hardness and preventing the formation of curls by curing shrinkage.

Furthermore, when the coating layer is formed only by using a photocurable resin, ultraviolet irradiation may sufficiently reach the bottom parts of the coating layer as the thickness of the coating layer increases, and therefore the incomplete curing of the coating layer may be problematic. However, according to the present invention, the incomplete curing may be compensated by performing all curing processes by heat and ultraviolet irradiation, since the coating layer includes both the thermocurable functional group and photocurable functional group. Accordingly, high hardness and the physical properties of the coating layer may further be strengthened.

In addition, when the dual-curable binder is used compared to a coating composition in which a binder including only thermocurable functional groups and a binder including only photocurable functional groups are mixed, it has advantages in that the tackiness of the coating layer after first curing is more favorable, thereby facilitating a secondary processing such as thermoforming, and that the crosslinking density can be increased, thereby enhancing the mechanical strength.

At least a portion of the plastic film of the present invention may be bent-shaped. The “at least a portion is bent-shaped” means that, from the side view of the plastic film in the direction of thickness, a part or the entire surface thereof is curve-shaped, preferably, in a shape of an arc. Accordingly, a part or the entire surface of the plastic film is in the shape of a curve.

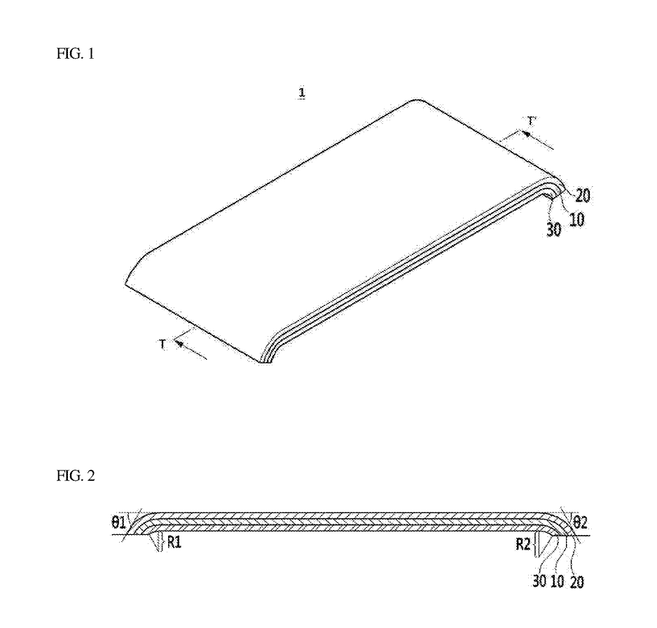

FIG. 1 is a perspective view of the plastic film according to one embodiment of the invention, FIG. 2 is a cross-sectional view illustrating the plastic film of FIG. 1. More specifically, FIG. 2 illustrates the cross-sectional view of the plastic film of FIG. 1 in the direction of T-T′.

With reference to FIGS. 1 and 2, the plastic film 1 includes a substrate 10 and coating layers 20, 30 formed on both surfaces of the substrate 10.

Two edges facing each other among the four edges of the plastic film illustrated in FIGS. 1 and 2 according to one embodiment of the invention may be bent-shaped. The curvature radii (R1, R2) of each edge may be each independently identical or different in the range of 2.5 to 15, but are not limited thereto, and they may vary depending on the shape, size and use of the plastic film needed.

In the plastic film of FIGS. 1 and 2, the angles between the front portion and the side portions (θ1, θ2) are each independently identical or different, and may vary within the range between 0 and 90° depending on the shape and size of the plastic film needed.

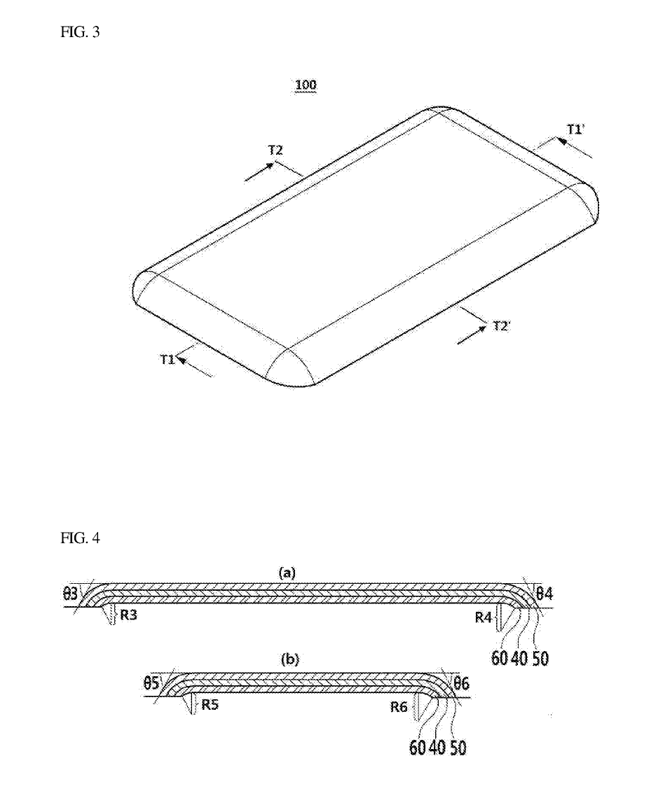

FIG. 3 illustrates the plastic film according to another embodiment of the present invention. FIG. 4 is a cross-sectional view illustrating the plastic film of FIG. 3. More specifically, FIG. 4(a) illustrates the cross-sectional view of the plastic film of FIG. 3 in the direction of T1-T1′, and the FIG. 4(b) illustrates the cross-sectional view of the plastic film of FIG. 3 in the direction of T2-T2′.

With reference to FIGS. 3 and 4, the plastic film 100 includes a substrate 40 and coating layers 50, 60 formed on both surfaces of the substrate 40.

The four edges and vertices of the plastic film illustrated in FIGS. 3 and 4 according to one embodiment of the invention may all be bent-shaped. The curvature radii (R3, R4, R5, R6) of each edge may be each independently identical or different in the range of 2.5 to 15, but are not limited thereto, and they may vary depending on the shape, size and use of the plastic film needed.

In the plastic film of FIGS. 3 and 4, the angles between the front portion and the side portions (θ3, θ4, θ5, θ6) are each independently identical or different, and may vary within the range between 0 and 90° depending on the shape and size of the plastic film needed.

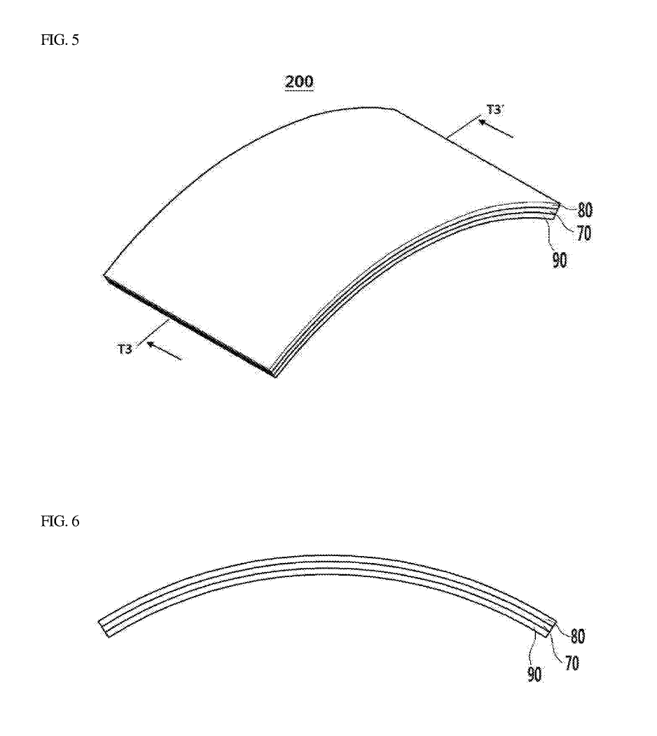

FIG. 5 illustrates the plastic film according to another embodiment of the present invention. FIG. 6 is a cross-sectional view illustrating the plastic film of FIG. 5. More specifically, FIG. 6 illustrates the cross-sectional view of the plastic film of FIG. 5 in the direction of T3-T3′.

With reference to FIGS. 5 and 6, the plastic film 200 includes a substrate 70 and coating layers 80, 90 formed on both surfaces of the substrate 70.

With reference to FIGS. 5 and 6, one surface of the plastic film according to one embodiment of the present invention may be entirely curve-shaped. The curvature radius of the curved plastic film may be in the range of 2.5 to 900, but is not limited thereto, and it may vary depending on the shape, size and use of the plastic film needed.

Further, the plastic film of the present invention was described with the accompanying FIGS. 1 to 6 as examples, but is not limited thereto, and it may have various types of three-dimensional structures. For example, the plastic film of the present invention may exist in all types of three-dimensional shapes wherein only one edge is bent-shaped, three edges are bent-shaped, only vertices are bent-shaped, all faces are curve-shaped, or have a hemispherical shape, etc., instead of a flat structure.

According to another embodiment of the present invention, it provides a method for preparing a plastic film including:

applying the coating composition including a dual-during binder including a thermocurable functional group and a photocurable functional group within a molecule, a photoinitiator, a heat-curing agent, and inorganic fine particles, on at least one surface of a support substrate;

forming a semi-cured coating layer by subjecting the applied coating composition to a first curing;

subjecting a support substrate on which the semi-cured coating layer is formed, to a thermoforming; and

subjecting the semi-cured coating layer to a second curing.

The detailed description of the coating composition, and of the dual-curable binder, photoinitiator, heat-curing agent, inorganic fine particles, or other components which may be included therein, and the specific examples thereof are as described above.

The coating composition including the components described above is applied to at least one surface of the support substrate. Here, the method for applying the coating composition is not particularly limited as long as it can be used in the technical field to which the present invention pertains, for example, a bar coating method, a knife coating method, a roll coating method, a blade coating method, a die coating method, a microgravure coating method, a comma coating method, a slot die coating method, a lip coating method, or a solution casting method, etc. may be used.

In addition, the coating layer may be applied such that the thickness after complete curing is within the range of about 20 μm or higher, for example, about 20 to about 300 μm, or about 50 to about 300 μm, or about 20 to about 200 μm, or about 50 to about 200 μm or about 20 to about 150 μm, or about 50 to about 150 μm, or about 20 to about 150 μm, or about 70 to about 150 μm.

Subsequently, the applied coating composition is subjected to a first curing.

The first curing is a step of curing some portions of the applied coating composition such that it may become vulnerable to a thermoforming process, which is a subsequent step.

The applied coating composition forms a semi-cured coating layer by the first curing process above. In the present specification, the semi-cured coating layer refers to a state in which the hardness calculated by Equation 1 below is about 10 to 70%.

Degree of curing(%)=(Number of moles of cured functional group)/(Photocurable functional group included in the coating composition+Number of moles of thermocurable functional group)×100 [Equation 1]

In other words, in the semi-cured coating layer, about 10 to about 70 moles or about 40 to about 60 moles of the functional groups are cured based on 100 moles of the curable functional groups included in the coating composition, that is, the entire curable functional group including thermocurable functional groups and photocurable functional groups. When the degree of curing of the semi-cured coating layer is way too below the range, the coating layer may adhere to the mold or the surface of the coating layer may undergo deformation due to strong tackiness of the surface, whereas when the degree of curing is way too high, it would be difficult to form a bent shape, or a crack may occur during the subsequent thermoforming process due to excessive stiffness.

According to one embodiment of the invention, the first curing may be a thermocuring process.

When the first curing is the thermocuring process, in the semi-cured coating layer includes the thermocurable functional group which is mainly at cured state, but it does not exclude the curing of the photocurable functional groups.

The thermocuring is a process by which the thermocurable functional groups included in the coating composition are cured. The thermocuring may be performed by heating at about 90 to about 150° C. or about 110 to about 130° C. for 1 minute to about 30 minutes or about 1 minute to about 5 minutes. When the thermocuring is performed at a temperature lower than the above range, it would be difficult to carry out subsequent thermoforming and the second curing process due to strong restoring force of the substrate, whereas when it is performed at a temperature beyond the above range, it would mostly have an impact on the support substrate, which is prone to heat, and thus, the overall physical properties of the plastic film may decrease.

According to another embodiment of the present invention, the first curing may be a photocuring process.

The photocuring is a process by which the photocurable functional groups included in the coating composition are cured. The UV dose during the photocuring may be, for example, about 20 to about 600 mJ/cm² or about 50 to 500 mJ/cm². A light source of the ultraviolet irradiation is not particularly limited as long as it can be used in the technical field to which the present invention pertains, for example, high-pressure mercury lamp, a metal halide lamp, a black light fluorescent lamp, etc. may be used. The photocuring step may be carried out by irradiation with the UV dose for about 30 seconds to 15 minutes or about 1 minute to about 10 minutes.

When the first curing is the photocuring process, the semi-cured coating layer includes the photocurable functional group which is mainly at cured state, but it does not exclude the curing of the thermocurable functional groups.

The semi-cured coating layer formed by the first curing above has a degree of curing at which it can be smoothly bent without cracks when applied with uniform pressure and heat, as the functional groups included in the coating composition are partially cured, and may become vulnerable to the subsequent thermoforming process as the tackiness of the surface decreases compared to that of the coating composition before curing.

Subsequently, the thermoforming process is performed for the support substrate on which the semi-cured coating layer is formed.

The thermoforming is a process by which the semi-cured coating layer and the support substrates are made into a desirable three-dimensional shape.

The thermoforming is performed by applying uniform heat to the support substrate on which the semi-cured coating layer is formed, that is, the semi-cured coating layer and the support substrate including the same. Here, the thermoforming may be accomplished by heating at about 90 to about 250° C. or about 100 to about 150° C. When the thermoforming is performed at a temperature lower than the above range, the desired three-dimensional shape may not be due to strong restoring force of the substrate, whereas when it is performed at a temperature beyond the above range, it would have an impact on the support substrate, and thus, the overall physical properties of the plastic film may decrease.

The thermoforming may be accomplished by reaching the aforementioned temperature range and maintaining it for a certain period, for example, about 30 to about 600 seconds or about 120 to about 300 seconds, but is not limited thereto, and it may vary depending on the types and thickness of the support substrate and the coating layer, the formed state, and pressure applied from a mold, etc.

According to one embodiment of the invention, the thermocuring may be accomplished together during the thermoforming process. That is, during the thermoforming process, the semi-cured coating layer is heated to a temperature at which the thermocurable functional group included in the coating composition can be cured, and thus, additional curing of the thermocurable functional group included in the coating composition may be carried out simultaneously along with the thermoforming process.

According to one embodiment of the invention, the thermoforming may be accomplished by placing the support substrate on which the semi-cured coating layer is formed into a mold with a suitable shape base on a desired three-dimensional shape, followed by heating it to a temperature at which the thermocuring of the mold is possible.

More specifically, the thermoforming may be carried out by placing the support substrate on which the semi-cured coating layer is formed between the upper and lower male and female molds and heating the molds to the temperature range above, followed by bringing into contact of the heated male and female molds with the support substrate on which the semi-cured coating layer is formed. Alternatively, the thermoforming may be carried out by placing a specimen into one of male or female mold, and subsequently applying vacuum and air pressure, thereby being adhered to the mold. Here, a uniform pressure, for example, about 1 to about 10 MPa or about 2 to about 3 MPa may be applied to the support substrate for efficient thermoforming.

According to another embodiment of the present invention, the thermoforming may be carried out by fixing the core portion of the support substrate on which the semi-cured coating layer is formed to a flat support portion and brining into contact of the portion in which a bent-shape is to be formed, for example, only the edge portions, with a heated mold or rod, followed by maintaining it for a certain period of time.

Subsequently, a second curing is performed for the semi-cured coating layer.

The second curing is a process by which the functional groups which remain in an uncured state are cured. The remaining functional groups included in the coating composition are cured in the semi-cured coating layer by the second curing process.

The semi-cured coating layer is fully cured by the second curing process, and thereby forming a plastic film with high hardness while having a three-dimensional shape by the previous thermoforming process. Here, the “fully cured” means that the curable functional groups included in the initially applied coating composition, that is, all curable functional groups including the thermocurable functional groups and the photocurable functional groups, are 100% cured, and if more than 80 moles thereof are cured, that is, if the degree of curing is about 80% or higher, they are considered as fully cured.

The second curing may be performed under the conditions where the film having completed the thermoforming, is either detached or not detached from the mold.

According to one embodiment of the present invention, the second curing may be a thermocuring process.

The thermocuring may be performed by heating at about 90 to about 150° C. or about 110 to about 130° C. for about 1 minute to about 30 minutes or about 1 minute to about 5 minutes.

According to another embodiment of the present invention, the second curing may be a photocuring process. The UV dose during the photocuring may be, for example, about 20 to about 600 mJ/cm² or about 50 to 500 mJ/cm². A light source of the ultraviolet irradiation is not particularly limited as long as it can be used in the technical field to which the present invention pertains, for example, a high-pressure mercury lamp, a metal halide lamp, a black light fluorescent lamp, etc. may be used. The photocuring step may be carried out by irradiation with the UV dose for about 30 seconds to 15 minutes or about 1 minute to about 10 minutes.

When the coating layer are formed on both surfaces of the support substrate, the plastic film of the present invention may be prepared by including applying the coating composition to one surface of the support substrate; forming a semi-cured coating layer by performing thermocuring for the coating composition applied to one surface; applying the coating composition to the back surface of the support substrate; forming a semi-cured coating layer by performing heating curing for the coating composition applied to back surface; performing thermoforming for the support substrate on which the semi-cured coating layers are formed on both surfaces; and performing thermocuring for the semi-cured coating layers.

Alternatively, the plastic film of the present invention may be prepared by including applying the coating composition to one surface of the support substrate; forming a semi-cured coating layer by simultaneously performing thermocuring and thermoforming for the coating composition applied to one surface; and performing photocuring relative to the semi-cured coating layer.

Alternatively, the plastic film of the present invention may be prepared by including applying the coating composition on one surface of the support substrate; forming a semi-cured coating layer by performing photocuring for the coating composition applied to one surface; applying the coating composition to the back surface of the support substrate; forming a semi-cured coating layer by performing photocuring for the coating composition applied to back surface; performing thermoforming for the support substrate on which the semi-cured coating layers are formed on both surfaces; and performing thermocuring for the semi-cured coating layers.

Alternatively, the plastic film of the present invention may be prepared by including applying the coating composition to one surface of the support substrate; forming a semi-cured coating layer by performing thermocuring relative to the coating composition applied to one surface; performing thermoforming relative to the support substrate on which the semi-cured coating layer is formed; applying the coating composition to the back surface of the support substrate; forming a semi-cured coating layer by performing thermocuring relative to the coating composition applied to back surface; and performing photocuring relative to the semi-cured coating layers. Here, the plastic film is already formed in a desired three-dimensional shape during the formation of the coating layer on one surface, and thus, the thermoforming process may be excluded after the formation of a semi-cured coating layer on the back surface.

Alternatively, the plastic film of the present invention may be prepared by including applying the coating composition to one surface of the support substrate; forming a semi-cured coating layer by performing photocuring for the coating composition applied to one surface; performing thermoforming for the support substrate on which the semi-cured coating layer is formed; applying the coating composition on the back surface of the support substrate; forming a semi-cured coating layer by performing photocuring for the coating composition applied to back surface; and performing thermocuring for the semi-cured coating layers.

The plastic film of the present invention prepared according to the preparation methods above exhibits a three-dimensional structure, high hardness, impact resistance, scratch resistance, high transparency, durability, light resistance, light transmittance, etc., and thus can be useful in a variety of fields. For example, the plastic film of the present invention may have a pencil hardness of 3H or higher, or 4H or higher, or 6H or higher at a load of 1 kg.

Further, the plastic film of the present invention may have a superior impact resistance which is sufficient to replace glass. For example, when a 22 g of a steel ball was freely dropped from a height of 40 cm, the plastic film of the present invention may not have an occurrence of cracks.

Furthermore, when steel wool#0000 was installed to a friction tester and let it move back and forth 400 times under a load of 500 g, only two scratches or less were made, thereby exhibiting excellent scratch resistance. Furthermore, the plastic film of the present invention may have a light transmittance of 92% or higher, and a haze value of 1.0% or below, or 0.5% or below, or 0.4% or below.

Furthermore, the plastic film of the present invention may have an initial color b* of 1.0 or below (CIE 1976 L*a*b* by color space). The difference between the initial color b* and the value of color b* after exposure to a UV lamp of UVB wavelength range for 72 hours may be 0.5 or below, or 0.4 or below.

The plastic film of the present invention can be used in various fields. For example, it may be used as a cover plate of mobile terminals, smart phones or tablet PC, and various displays with a flat shape or a three-dimensional shape, or as a device substrate.

Hereinafter, the effects of the present invention will be described in more detail with reference to specific embodiments. However, the examples are provided for illustrative purposes only, and the scope of the present invention should not be limited thereto in any manner.

### EXAMPLES

Preparation Example of Dual-Curable Binder

### Preparation Example 1

SMP-220A was prepared as a dual-curable binder containing a hydroxy group and an acrylate group within a molecule (available from Public Chemical Co., Ltd. (Japan), solid content 50% (in MIBK), equivalent weight of acrylate=220 g/eq, equivalent weight of hydroxyl=220 g/eq, Mw=30,000-40,000 g/mol).

### Preparation Example 2

SMP-360A was prepared as a dual-curable binder containing a hydroxy group and an acrylate group within a molecule (available from Public Chemical Co., Ltd. (Japan), solid content 50% (in MIBK), equivalent weight of acrylate=360 g/eq, equivalent weight of hydroxyl=360 g/eq, Mw=30,000-40,000 g/mol).

### Preparation Example 3

SMP-550A was prepared as a dual-curable binder containing a hydroxy group and an acrylate group within a molecule (available from Public Chemical Co., Ltd. (Japan), solid content 50% (in MIBK), equivalent weight of acrylate=550 g/eq, equivalent weight of hydroxyl=550 g/eq, Mw=30,000-40,000 g/mol).

### Example 1

6 g of the dual-curable binder of Preparation Example 1 (trade name: SMP-220A), 12 g of silica-trimethylolpropane triacrylate (TMPTA) complex (6 g of silica, 6 g of TMPTA) in which 50% by weight of nanosilica having a particle diameter of 20 to 30 nm is dispersed, 6.47 g of hydroxy-dipentaerythritol hexaacrylate (trade name: A-9750W, manufacturer: NK Chemicals), 7.11 g of alicyclic polyisocyanate (trade name; MF-K60X, manufacturer: AsahiKasei), 0.15 g of dibutyltin dilaurate (BDTDL, 0.1 wt % in MEK) as a heat-curing agent, 0.15 g of Tego 410® (0.1 wt % in MEK) and 0.15 g of Tego 450® (0.1 wt % in MEK), which is an additive manufactured by Tego, as flowability improving agents, 0.2 g of photoinitiator (trade name: Darocur TPO), and 0.1 g of benzotriazole-based anti-yellowing agent (trade name: Tinuvin 400) were mixed to prepare a first coating composition.

The first coating composition was applied to a PET support substrate with a size of 10 cm×20 cm and a thickness of 188 μm. Thereafter, thermocuring was performed at a temperature of 130° C. for 30 minutes.

A second coating composition was also prepared in the same manner, and was applied on the back surface of the support substrate. Then, thermocuring was performed at a temperature of 130° C. for 30 minutes to prepare a specimen. After the completion of thermocuring, the thickness of the first and second coating layers formed on both surfaces of the substrate were each 100 μm.

The specimen prepared as described above was placed between male and female molds which enable two edges facing each other to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. The recovered specimen was completely cured under a UV lamp having a wavelength of 280 to 350 nm, and thereby, a plastic film having a three-dimensional structure in which the two edges facing each other are bent at 90° with 2.5R was prepared.

### Example 2

6 g of the dual-curable binder of Preparation Example 1 (trade name: SMP-220A), 7.48 g of silica-dipentaerythritol hexaacrylate (DPHA) complex (3.74 g of silica, 3.74 g of DPHA) in which 50% by weight of nanosilica having a particle diameter of 20 to 30 nm is dispersed, 2.64 g of hydroxy-dipentaerythritol hexaacrylate (trade name: A-9750W, manufacturer: NK Chemicals), 7.11 g of alicyclic polyisocyanate (trade name; MF-K60X, manufacturer: AsahiKasei), 0.15 g of dibutyltin dilaurate (BDTDL, 0.1 wt % in MEK) as a heat-curing agent, 0.15 g of Tego 410® (0.1 wt % in MEK) and 0.15 g of Tego 450® (0.1 wt % in MEK), which is an additive manufactured by Tego, as flowability improving agents, 0.2 g of photoinitiator (trade name: Darocur TPO), and 0.1 g of benzotriazole-based anti-yellowing agent (trade name: Tinuvin 400) were mixed to prepare a first coating composition.

The first coating composition was applied to a PET support substrate with a size of 15 cm×20 cm and a thickness of 188 μm. Thereafter, thermocuring was performed at a temperature of 130° C. for 30 minutes.

A second coating composition was also prepared in the same manner, and was applied on the back surface of the support substrate. Then, thermocuring was performed at a temperature of 13° C. for 30 minutes to prepare a specimen. After the completion of thermocuring, the thickness of the first and second coating layers formed on both surfaces of the substrate were each 100 μm.

The specimen prepared as described above was placed between male and female molds which enable four edges to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. The recovered specimen was completely cured under a UV lamp having a wavelength of 280 to 350 nm, and thereby, a plastic film having a three-dimensional structure in which the four edges are bent at 90° with 2.5R was prepared.

### Example 3

The specimen prepared in the same manner as described in Example 1 above was placed between male and female molds which enable it to have 700R in the longitudinal direction and 300R in the lateral direction, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. The recovered specimen was completely cured under a UV lamp having a wavelength of 280 to 350 nm, and thereby, a plastic film having a three-dimensional structure, which is bent at 300R to 700R over the full specimen, was prepared.

### Example 4

6 g of the dual-curable binder of Preparation Example 2 (trade name: SMP-360A), 12 g of silica-trimethylolpropane triacrylate (TMPTA) complex (6 g of silica, 6 g of TMPTA) in which 50% by weight of nanosilica having a particle diameter of 20 to 30 nm is dispersed, 6.47 g of hydroxy-dipentaerythritol hexaacrylate (trade name: A-9750W, manufacturer: NK Chemicals), 4.35 g of alicyclic polyisocyanate (trade name; MF-K60X, manufacturer: AsahiKasei), 0.15 g of dibutyltin dilaurate (BDTDL, 0.1 wt % in MEK) as a heat-curing agent, 0.15 g of Tego 410® (0.1 wt % in MEK), which is an additive manufactured by Tego, as a flowability improving agent, and 0.2 g of photoinitiator (trade name: Darocur TPO) were mixed to a first coating composition.

The first coating composition was applied to a PET support substrate with a size of 15 cm×20 cm and a thickness of 188 μm. Thereafter, thermocuring was performed at a temperature of 130° C. for 30 minutes.

A second coating composition was also prepared in the same manner, and was applied on the back surface of the support substrate. Then, thermocuring was performed at a temperature of 130° C. for 30 minutes to prepare a specimen. After the completion of thermocuring, the thickness of the first and second coating layers formed on both surfaces of the substrate were each 100 μm.

The specimen prepared as described above was placed between male and female molds which enable two edges facing each other to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. The recovered specimen was completely cured under a UV lamp having a wavelength of 280 to 350 nm, and thereby, a plastic film having a three-dimensional structure in which the two edges facing each other are bent at 90° with 2.5R was prepared.

### Example 5

6 g of the dual-curable binder of Preparation Example 3 (trade name: SMP-550A), 12 g of silica-trimethylolpropane triacrylate (TMPTA) complex (6 g of silica, 6 g of TMPTA) in which 50% by weight of nanosilica having a particle diameter of 20 to 30 nm is dispersed, 6.47 g of hydroxy-dipentaerythritol hexaacrylate (trade name: A-9750W, manufacturer: NK Chemicals), 2.85 g of alicyclic polyisocyanate (trade name; MF-K60X, manufacturer: AsahiKasei), 0.15 g of dibutyltin dilaurate (BDTDL, 0.1 wt % in MEK) as a heat-curing agent, 0.15 g of Tego 410® (0.1 wt % in MEK), which is an additive manufactured by Tego, as a flowability improving agent, and 0.2 g of photoinitiator (trade name: Darocur TPO) were mixed to prepare a first coating composition.

The first coating composition was applied on a PET support substrate with a size of 15 cm×20 cm and a thickness of 188 μm. Thereafter, thermocuring was performed at a temperature of 130° C. for 30 minutes.

A second coating composition was also prepared in the same manner, and was applied on the back surface of the support substrate. Then, thermocuring was performed at a temperature of 130° C. for 30 minutes to prepare a specimen. After the completion of thermocuring, the thickness of the first and second coating layers formed on both surfaces of the substrate were each 100 μm.

The specimen prepared as described above was placed between male and female molds which enable two edges facing each other to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. The recovered specimen was completely cured under a UV lamp having a wavelength of 280 to 350 nm, and thereby, a plastic film having a three-dimensional structure in which the two edges facing each other are bent at 90° with 2.5R was prepared.

### Comparative Example 1

10 g of trimethylolpropane triacrylate (TMPTA), 0.1 g of Irgacure 127 as a photoinitiator, and 0.1 g of Tego Flow 410 (10 wt % in MEK) as a flowability improving agent were mixed to prepare a coating composition. The coating composition was applied on a PET support substrate with a thickness of 188 μm, and then was completely cured under a UV lamp having a wavelength of 280 to 350 nm.

The specimen prepared as described above was placed between male and female molds which enable two edges facing each other to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen, thereby preparing a plastic film.

### Comparative Example 2

10 g of trimethylolpropane triacrylate (TMPTA), 0.1 g of Irgacure 127 as a photoinitiator, and 0.1 g of Tego Flow 410 (10 wt % in MEK) as a flowability improving agent were mixed to prepare a coating composition. The coating composition was applied on a PET support substrate with a thickness of 188 and then was subjected to semi-curing under a UV lamp having a wavelength of 280 to 350 nm, such that the degree of curing became about 40%.

The specimen prepared as described above was placed between male and female molds which enable two edges facing each other to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. Subsequently, the molded specimen was completely cured under a UV lamp having a wavelength of 280 to 350 nm to prepare a plastic film.

### Comparative Example 3

A first and a second coating compositions were prepared in the same manner as described in Example 1 above.

Thereafter, the first coating composition was applied on a PET support substrate with as a size of 15 cm×20 cm and a thickness of 188 μm. Subsequently, thermocuring was performed at a temperature of 130° C. for 6 hours.

A second coating composition was also prepared in the same manner, and was applied on the back surface of the support substrate. Then, thermocuring was performed at a temperature of 130° C. for 6 hours to prepare a specimen. After the completion of thermocuring, the thickness of the first and second coating layers formed on both surfaces of the substrate were each 100 μm.

The specimen prepared as described above was placed between male and female molds which enable two edges facing each other to have a bending at 90° with 2.5R, and allowed to stand for 1 minute at 120° C., and the upper and lower molds were adhered under a pressure of 2 MPa. After the completion of adhesion, the specimen was allowed to stand for 3 minutes, and the upper and lower molds were separated to recover the molded specimen. The recovered specimen was completely cured under a UV lamp having a wavelength of 280 to 350 nm to prepare a plastic film.

### Experimental Example

<Measurement Method>

1) Pencil Hardness

The pencil hardness was measured three times using a pencil hardness tester under a load of 1.0 kg according to the measurement standards of JIS K5400, and it was confirmed that no starches were found in the hardness.

2) Formability

After adjusting the temperature of the upper and lower molds of a thermoforming machine to 130° C., thermoforming was performed under a pressure of 2 to 3 MPa by placing the specimen between the molds. The formability was evaluated based on the variation of flatness relative to the surface of the molds after thermoforming, the formation of cracks in the bent portions, discoloration, and whether the maximum separation distance is less than 0.5 mm when combined with a structure having the same shape as the mold. It was either evaluated as OK when all categories were met or as NG when even one category was not met.

3) Tackiness

After the first curing and before thermoforming, the peel strength (unit: N/2 cm) between the first cured film and a protective film was measured under the condition where the peel rate is 50 mm/min and the peel angle is 90° using a texture analyzer (Stable Micro Systems, UK), and then the degree of tackiness was evaluated.

When the peel strength was less than 0.1, it was indicated as ⊚, when the peel strength was between 0.1 and 0.5, it was indicated as O, when the peel strength was between 0.5 and 1, it was indicated as A, and when the peel strength was 1 or higher, it was indicated as X.

4) Light Resistance

The difference of color b* before and after the exposure to a UV lamp of a UVB wavelength range for 72 hours was measured, and when the difference was less than 1, it was indicated as OK.

5) Transmittance and Haze

The transmittance and haze were measured by a spectrophotometer (device name: COH-400). When the transmittance is greater than 91%, it was evaluated as OK, and when the haze was less than 1.0%, it was evaluated as OK.

6) Impact Resistance

The initial height at which a crack was formed was measured when 22 g of a steel ball was freely dropped on the film at a height 10 cm for 10 times by increasing the height at a 5 cm interval. The measurement results of the physical properties are shown in Table 1.

TABLE 1

| | | | | | | Comparative | Comparative | Comparative |
|---|---|---|---|---|---|---|---|---|
| | Example 1 | Example 2 | Example 3 | Example 4 | Example 5 | Example 1 | Example 2 | Example 3 |
| Pencil | 6H | 4H | 6H | 5H | 4H | 3H | 3H | 6H |
| hardness | | | | | | | | |
| Formability | OK | OK | OK | OK | OK | NG | NG | NG |
| Tackiness | ◯ | ⊚ | ◯ | ◯ | ◯ | ⊚ | Δ | ⊚ |
| Light | OK | OK | OK | OK | OK | NG | NG | OK |
| resistance | | | | | | | | |
| Transmittance | OK | OK | OK | OK | OK | OK | OK | OK |
| Haze | OK | OK | OK | OK | OK | OK | OK | OK |
| Impact | 40 cm | 50 cm | 40 cm | 50 cm | 55 cm | 10 cm | 30 cm | 30 cm |
| resistance | | | | | | | | |

As shown in Table 1, the plastic films according to Examples 1 to 5 of the present invention exhibited good formability and tackiness as well as high hardness, thereby being able to show various three-dimensional structures. However, Comparative Examples 1 to 3, in which the thermoforming was performed for the fully-cured coating layer, instead of the semi-cured coating layer, confirmed that the formability was not as good due to the occurrence of cracks in the bent portions, etc., and thus it was not possible to form a bend-forming. In addition, in the case of Comparative Example 2 which uses the coating composition only including acrylate-based monomers as a binder, although the thermoforming was carried out after the semi-curing process, the coating layer was adhered to the mold or the surface of the coating layer went through deformation due to high tackiness of the semi-cured coating layer. In such case, the formability was also not good.

1. A coating composition comprising a dual-curable binder including a thermocurable functional group and a photocurable functional group within a molecule, a photoinitiator, a heat-curing agent, and inorganic fine particles.

2. The coating composition according to claim 1, wherein the thermocurable functional group and the photocurable functional group is included in a molar ratio of 1:9 to 9:1.

3. The coating composition according to claim 1, wherein the dual-curable binder is comprised in an amount of 10 to 50 parts by weight, the photoinitiator is comprised in an amount of 0.1 to 5 parts by weight, the heat-curing agent is comprised in an amount of 10 to 50 parts by weight, and the inorganic fine particles are comprised in an amount of 1 to 40 parts by weight, based on 100 parts by weight of the total coating composition.

4. The coating composition according to claim 1, further comprising 3 to 6 functional acrylate-based monomers.

5. The coating composition according to claim 4, wherein comprising the 3 to 6 functional acrylate-based monomers in an amount of 5 to 50 parts by weight based on 100 parts by weight of the total coating composition.

6. The coating composition according to claim 1, wherein an equivalent weight of the thermocurable functional group and the photocurable functional group of the dual-curable binder are each independently identical or different in a range of 80 to 1,500 g/eq.

7. A plastic film in which at least a portion is bent-shaped, comprising:
a support substrate; and
a coating layer formed on at least one surface of the support substrate, wherein the coating layer comprises a cured product of a dual-curable binder containing a thermocurable functional group and a photocurable functional group within a molecule, and inorganic fine particles.

8. The plastic film according to claim 7, wherein comprising the thermocurable functional group and the photocurable functional group in a molar ratio of 1:9 to 9:1.

9. The plastic film according to claim 7, wherein two edges facing each other are bent-shaped, and the radius of the curvature of each bent edge is each independently identical or different in a range of 2.5 to 15.

10. The plastic film according to claim 7, wherein all four edges are bent-shaped, and the radius of the curvature of each bent edge is each independently identical or different in a range of 2.5 to 15.

11. The plastic film according to claim 7, wherein one surface is entirely bent-shaped, and the radius of the curvature is in a range of 2.5 to 900.

12. The plastic film according to claim 7, wherein the support substrate has a glass transition temperature in a range of 80 to 250° C.

13. The plastic film according to claim 7, wherein the coating layer has a thickness of the coating layer in a range of 20 to 300 μm.

14. The plastic film according to claim 7, having a pencil hardness of 3H or higher at a load of 1 kg.

15. A method for preparing a plastic film comprising:
applying a coating composition of claim 1 on at least one surface of a support substrate;
forming a semi-cured coating layer by subjecting the applied coating composition to a first curing;
subjecting the support substrate on which the semi-cured coating layer is formed, to thermoforming; and
subjecting the semi-cured coating layer to a second curing.

16. The method for preparing a plastic film according to claim 15, wherein 10 to 70 moles of the functional groups are cured in the semi-cured coating layer based on 100 moles of the total curable functional groups containing the thermocurable functional group and photocurable functional group.

17. The method for preparing a plastic film according to claim 15, wherein the thermoforming is carried out at temperature of 90 to 250° C.

18. The method for preparing a plastic film according to claim 15, wherein at least a portion of the plastic film has a bent shape by the thermoforming.

19. The method for preparing a plastic film according to claim 15, wherein the first curing is thermocuring, and the second curing is photocuring.

20. The method for preparing a plastic film according to claim 15, wherein the first curing is photocuring, and the second curing is thermocuring.
